(19) United States
(12) Patent Application Publication
(10) Pub. No.: US 2026/0098342 A1
(43) Pub. Date: Apr. 9, 2026

(54) METHOD FOR MANUFACTURING SOL-GEL-BASED TiO2 CRYSTALLINE METASURFACE AND TiO2 CRYSTALLINE METASURFACE MANUFACTURED THEREBY

(71) Applicant: POSTECH Research and Business Development Foundation, Pohang-si (KR)

(72) Inventors: Junsuk RHO, Pohang-si (KR); Joohoon Kim, Pohang-si (KR); Minseok Choi, Pohang-si (KR); Heon Lee, Seoul (KR); Won Joong Kim, Seoul (KR); Chanwoong Park, Seoul (KR); Hyoln Song, Seoul (KR)

(73) Assignee: POSTECH Research and Business Development Foundation, Pohang-si (KR)

(21) Appl. No.: 19/351,508

(22) Filed: Oct. 7, 2025

(30) Foreign Application Priority Data
Oct. 8, 2024 (KR) 10-2024-0136967
May 28, 2025 (KR) 10-2025-0069804
Sep. 30, 2025 (KR) 10-2025-0142844

(51) Int. Cl. C23C 18/12; C04B 35/46

(52) U.S. Cl. CPC C23C 18/1254; C04B 35/46; C23C 18/1216; C23C 18/1295

(57) ABSTRACT

The present disclosure provides a method for manufacturing a TiO₂ crystalline metasurface, the method including: (S100) coating a substrate with a TiO₂ sol-gel ink; (S200) arranging a mold having a concave nanopattern on the substrate coated with the TiO₂ sol-gel ink to form an assembly; (S300) solidifying the TiO₂ sol-gel ink inside the assembly; and (S400) after releasing the mold, performing a heat treatment on a TiO₂ nanostructure to crystallize TiO₂.

### CROSS-REFERENCE TO RELATED APPLICATIONS

This application claims priority under 35 U.S.C. § 119 to Korean Patent Application No. 10-2024-0136967, filed on Oct. 8, 2024; 10-2025-0069804, filed on May 28, 2025; 10-2025-0142844, Sep. 30, 2025; in the Korean Intellectual Property Office, the disclosure of which is incorporated herein by reference in its entirety.

### TECHNICAL FIELD

The following disclosure relates to a method for manufacturing a sol-gel-based TiO₂ crystalline metasurface and a TiO₂ crystalline metasurface manufactured thereby.

### BACKGROUND

A metasurface is an ultrathin array of nanostructures capable of precisely controlling light phase, amplitude, polarization, and the like within a thin layer, and has attracted attention as a next-generation optical element that may overcome the limitations of conventional optical elements. In particular, depending on the shape and arrangement of the nanostructures, metasurfaces can be applied in various fields, including metalenses, holograms, biosensors, and LiDAR.

The performance of the metasurface is determined by a refractive index of the constituent material and by a precise fabrication technology of the nanostructure. In particular, titanium dioxide (TiO₂) has a high refractive index and a low optical absorption. Particularly, crystalline titanium dioxide (anatase or rutile) exhibits a higher refractive index than amorphous titanium dioxide, which is advantageous for improving the optical performance of the metasurface.

However, although amorphous TiO₂, having a refractive index of about 2.3 and a low extinction coefficient, has been actively utilized for visible-light metasurfaces, crystalline TiO₂ has limitations in commercialization due to problems such as high cost, low productivity, and complicated processes, despite its higher refractive index. Representative processes such as electron beam lithography, atomic layer deposition (ALD), and etching require significant time and cost, and it is difficult to realize crystalline TiO₂ with uniformity and high quality over a large area.

Electron beam lithography provides extremely high resolution; however, it is inefficient for application to large-area wafers due to its slow processing speed and high cost, and it is unsuitable for repetitive production, thus limiting its use in industrial mass production. Atomic layer deposition (ALD) enables uniform thin-film deposition and thickness control; however, it has an extremely slow deposition rate, requires a long time for stacking complex three-dimensional structures, and, in particular, is limited to a height of 600 nm in the manufacture of TiO₂ metasurfaces, resulting in restriction of structural design. Etching is utilized for TiO₂ thin-film patterning; however, optical performance degradation occurs due to sidewall slopes and surface roughness, and the overall efficiency of the metasurface decreases due to damaged surfaces and non-uniform patterns.

In order to overcome such problems, imprint processes using molds have been studied, which have the advantage of enabling large-area production but are limited to a height of 600 nm in the manufacture of TiO₂ metasurfaces, resulting in restriction of structural design. In addition, there is a risk that meta-particles may be damaged or peeled off during a mold release process, which may cause degradation of optical performance, and it is difficult to manufacture metasurfaces with verticality and a high aspect ratio. Furthermore, since the mold itself is vulnerable to thermal deformation, there is a limitation in that a deformed mold cannot be used to repeatedly and reproducibly manufacture metasurfaces having the same structures.

As described above, conventional techniques have significant limitations in terms of cost, production speed, and process complexity in realizing crystalline TiO₂ with high quality on large-area wafers, making practical commercialization and mass production difficult.

### SUMMARY

An embodiment of the present disclosure is directed to providing a method for manufacturing a sol-gel-based TiO₂ crystalline metasurface that enables stable formation of a high-resolution nanopattern on a large-area wafer.

Another embodiment of the present disclosure is directed to providing a method for manufacturing a metasurface having a uniform crystalline phase and high efficiency by solving a reaction rate and shrinkage problems of sol-gel TiO₂.

Still another embodiment of the present disclosure is directed to providing a method for manufacturing a sol-gel-based TiO₂ crystalline metasurface that can selectively form anatase and rutile crystalline phases through a low-cost and high-speed process.

Yet another embodiment of the present disclosure is directed to providing a method for manufacturing a sol-gel-based TiO₂ crystalline metasurface that can stably and reproducibly manufacture the same metasurface structures repeatedly.

In one general aspect, a method for manufacturing a TiO₂ crystalline metasurface includes: (S100) coating a substrate with a TiO₂ sol-gel ink; (S200) arranging a mold having a concave nanopattern on the substrate coated with the TiO₂ sol-gel ink to form an assembly; (S300) solidifying the TiO₂ sol-gel ink inside the assembly; and (S400) after releasing the mold, performing a heat treatment on a TiO₂ nanostructure to crystallize TiO₂.

In an exemplary embodiment of the present disclosure, step (S300) may include: (S310) removing a residual solvent of the sol-gel ink at a temperature of 50° C. to 100° C.; and (S320) shrinking the nanostructure formed on the substrate by a heat treatment.

In an exemplary embodiment of the present disclosure, in step (S310), the residual solvent may be removed by applying a pressure of 300 kPa to 600 kPa.

In an exemplary embodiment of the present disclosure, the heat treatment of step (S320) may be performed at a temperature of 180° C. to 250° C.

In an exemplary embodiment of the present disclosure, the mold may be formed of a polymer having a heat distortion temperature of 250° C. or higher.

In an exemplary embodiment of the present disclosure, the mold may be formed of polyimide.

In an exemplary embodiment of the present disclosure, a heat treatment temperature of step (S400) may be 600° C. to 1,000° C.

In an exemplary embodiment of the present disclosure, the concave nanopattern of the mold may be formed to be 20% to 30% larger in length than meta-particles to be manufactured.

In another general aspect, there is provided a TiO₂ crystalline metasurface manufactured by the method for manufacturing a TiO₂ crystalline metasurface.

In an exemplary embodiment of the present disclosure, the TiO₂ crystal may be in an anatase crystalline phase or a rutile crystalline phase.

In an exemplary embodiment of the present disclosure, a pattern period of the TiO₂ metasurface may be 70 nm or more and 450 nm or less.

In an exemplary embodiment of the present disclosure, a meta-particle of the TiO₂ crystalline metasurface may have a height of 300 nm to 650 nm, a length of 150 nm to 300 nm, and a width of 100 nm to 260 nm.

In an exemplary embodiment of the present disclosure, a refractive index of the TiO₂ crystal may be 2.8 to 3.2.

In an exemplary embodiment of the present disclosure, a conversion efficiency of the metasurface may be 80% or more in a wavelength region of 400 nm to 700 nm.

Other features and aspects will be apparent from the following detailed description, the drawings, and the claims.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIGS. 1A to 1C illustrate a synthesis mechanism of TiO₂ sol-gel, XRD analysis according to crystallization, and a change in refractive index.

FIG. 2 illustrates a process diagram of manufacturing a metasurface according to the present disclosure.

FIGS. 3A to 3G illustrate TiO₂ crystalline metasurface structures manufactured by a method for manufacturing a sol-gel-based TiO₂ crystalline metasurface according to an exemplary embodiment of the present disclosure, and a wafer-scale implementation result.

FIGS. 4A to 4D illustrate graphs showing the conversion efficiency of the metasurface according to the height, length, period, and width of the meta-atom.

FIGS. 5A and 5B illustrate broadband conversion efficiency characteristics from 400 nm to 700 nm of meta-atoms designed for amorphous TiO₂, anatase, and rutile, and numerical apertures (NAs) of metalenses calculated at different periods (300 nm, 350 nm, 400 nm, and 450 nm) for respective wavelengths (450 nm, 532 nm, and 635 nm).

### DETAILED DESCRIPTION OF EMBODIMENTS

The advantages and features of the present disclosure, and methods for achieving them, will become apparent from the exemplary embodiments described in detail below. However, the present disclosure is not limited to the exemplary embodiments disclosed hereinafter, and may be embodied in various different forms. The present exemplary embodiments are provided so that the present disclosure is complete and fully conveys the scope of the present disclosure to those skilled in the art, and the scope of the present disclosure is defined only by the appended claims.

Unless otherwise defined, all terms (including technical and scientific terms) used in the present specification may be construed as having the meanings commonly understood by those skilled in the art to which the present disclosure pertains.

Unless the context clearly indicates otherwise, the singular forms used in the present specification may be intended to include the plural forms.

A numerical range used in the present specification includes upper and lower limits and all values within these limits, increments logically derived from a form and span of a defined range, all double limited values, and all possible combinations of the upper and lower limits in the numerical range defined in different forms. Unless otherwise specifically defined in the present specification of the present disclosure, values out of the numerical range that may occur due to experimental errors or rounded values also fall within the defined numerical range.

The expression “comprise(s)” as used in the present specification is intended to be an open-ended transitional phrase having an equivalent meaning to “include(s)”, “contain(s)”, “have (has)”, and “are (is) characterized by”, and does not exclude additional elements, materials, or steps not recited herein.

In the present specification, the term “meta-atom” is defined as an individual unit structure constituting a metasurface, which is a repeating unit (unit cell) mainly having a function of interacting with electromagnetic waves.

Hereinafter, a method for manufacturing a sol-gel-based TiO₂ crystalline metasurface according to the present disclosure and a TiO₂ crystalline metasurface manufactured thereby will be described in detail. However, the description is merely exemplary and the present disclosure is not limited to specific exemplary embodiments described by way of example.

The present disclosure provides a method for manufacturing a TiO₂ crystalline metasurface, the method including: (S100) coating a substrate with a TiO₂ sol-gel ink; (S200) arranging a mold having a concave nanopattern on the substrate coated with the TiO₂ sol-gel ink to form an assembly; (S300) solidifying the TiO₂ sol-gel ink inside the assembly; and (S400) after releasing the mold, performing a heat treatment on a TiO₂ nanostructure to crystallize TiO₂.

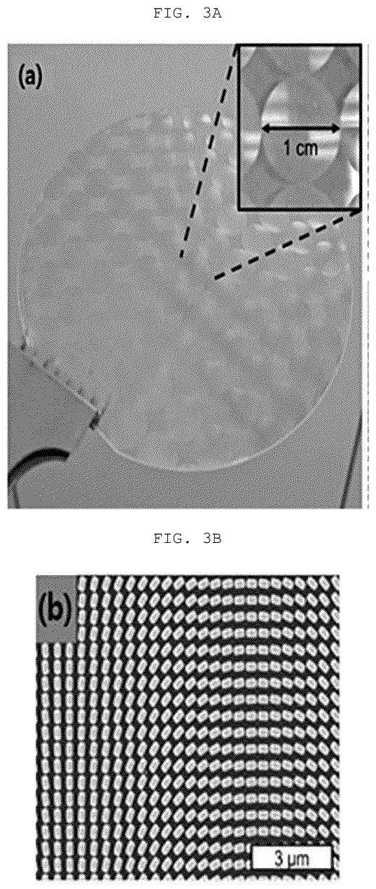

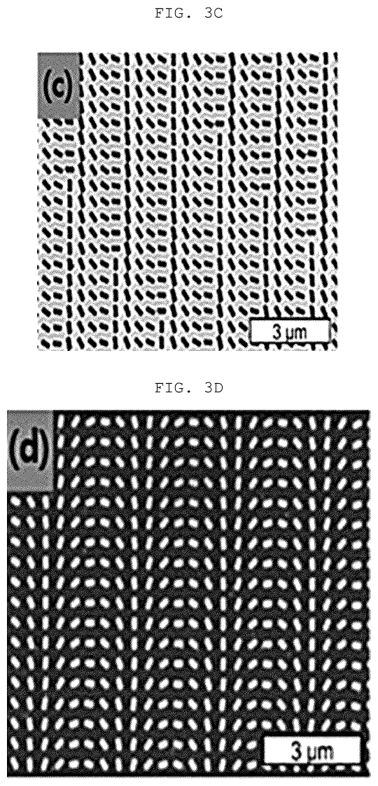

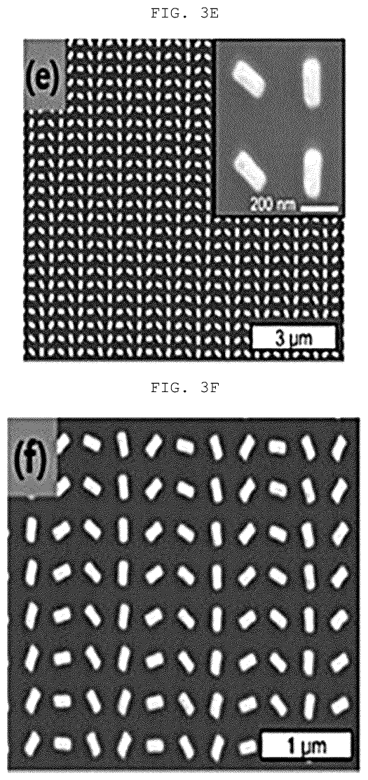

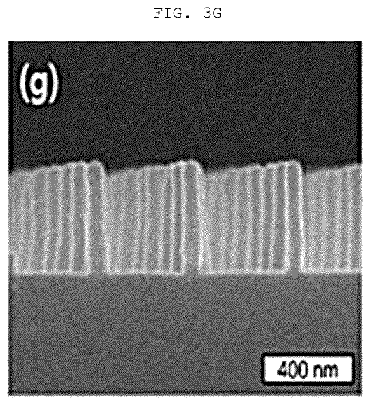

The present disclosure may overcome limitations of conventional electron beam lithography, ALD, and etching processes, which are complicated and costly, by using a TiO₂ sol-gel ink. High-resolution nanopatterns may be efficiently implemented at a wafer scale in a low-cost and high-speed manner, and uniform crystallinity and fine pattern formation may be achieved by controlling a reaction rate and shrinkage of the sol-gel ink. Specifically, as illustrated in FIGS. 3A to 3G, the nanopatterns have excellent verticality and a high aspect ratio, and a metasurface with high resolution and high precision may be formed on a large area.

In addition, by precisely controlling the crystallinity of TiO₂ through the heat treatment process of step (S400), it is possible to stably manufacture a metasurface having a higher refractive index and excellent optical performance compared with conventional amorphous TiO₂.

First, a method for preparing the TiO₂ sol-gel ink in step (S100) will be described.

In an exemplary embodiment of the present disclosure, step (S100) may include (S110) preparing a TiO₂ sol solution containing a titanium precursor, an organic solvent, a stabilizer, and water; and (S120) stirring the TiO₂ sol solution until the TiO₂ sol solution becomes transparent.

In step (S110), after adding a stabilizer to an organic solvent, magnetic stirring may be performed at a temperature of 30° C. to 60° C.

More specifically, a lower limit of the magnetic stirring temperature may be 30° C. or higher, 35° C. or higher, 40° C. or higher, 45° C. or higher, or 50° C. or higher, and an upper limit of the magnetic stirring temperature may be 60° C. or lower, 55° C. or lower, or 50° C. or lower. Still more specifically, the magnetic stirring temperature may be 30° C. to 60° C., 40° C. to 60° C., or 45° C. to 55° C., but is not limited thereto. When the magnetic stirring is performed within the above temperature range, the stabilizer may effectively act to prevent the sol from solidifying or precipitating. The magnetic stirring may be performed for 1 hour to 3 hours to homogenize the sol.

After the homogenization, a titanium precursor, a small amount of an organic solvent, and water are added to prepare a TiO₂ sol solution, and the solution may be stirred in step (S120).

In an exemplary embodiment of the present disclosure, the organic solvent may be one or more selected from the group consisting of ethanol, methanol, propanol, and butanol. More preferably, the organic solvent may be ethanol, but is not limited thereto.

In an exemplary embodiment of the present disclosure, the titanium precursor may be one or two or more selected from the group consisting of titanium isopropoxide (TIP), titanium tetraethoxide (TTE), titanium tetraisopropoxide (TTIP), titanium tetrabutoxide (TTB), tetrabutyl orthotitanate (TBOT), and mixtures thereof, but is not limited thereto. More specifically, the titanium precursor may be tetrabutyl orthotitanate (TBOT).

In an exemplary embodiment of the present disclosure, the stabilizer may be an alkanolamine. Specifically, the stabilizer may be one or two or more selected from the group consisting of ammonium hydroxide, ammonium chloride, methylamine, ethylamine, propylamine, isopropylamine, butylamine, cyclohexylamine, dimethylamine, diethylamine, trimethylamine, triethylamine, and mixtures thereof, but is not limited thereto. More preferably, the stabilizer may be diethylamine, but is not limited thereto.

In an exemplary embodiment of the present disclosure, in step (S100), the TiO₂ sol-gel ink may be applied to a substrate by a method selected from the group consisting of dip coating, spray coating, spin coating, die coating, roll coating, slot-die coating, bar coating, gravure coating, comma coating, curtain coating, and micro-gravure coating, but is not limited thereto. Specifically, the TiO₂ sol-gel ink may be applied by spin coating, but is not limited thereto.

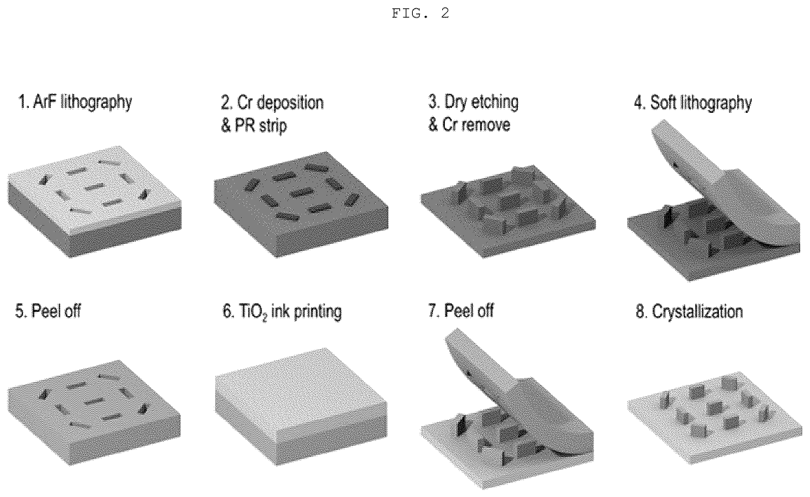

In step (S200), the term “arranging” means an act of positioning a mold having a concave nanopattern on a substrate coated with the sol-gel ink in an aligned state at a predetermined position and orientation, and includes a process of allowing the pattern of the mold and the surface of the substrate to be brought into parallel contact with each other so as to form an assembly. Specifically, as illustrated in FIG. 2, step (S200) corresponds to a pretreatment step of bringing the mold onto the substrate, and subsequently transferring a mold pattern to the sol-gel ink through a drying or curing process.

In an exemplary embodiment of the present disclosure, in step (S200), the concave nanopattern of the mold may be formed to be 20% to 30% larger in length than a meta-particle to be finally manufactured.

By forming the concave nanopattern of the mold to be 20% to 30% larger than the length of each side of a meta-particle to be finally manufactured, shrinkage of the sol-gel TiO₂ ink during a drying and heat treatment may be effectively compensated. By forming the pattern of the mold to be larger than the length of the meta-particle, dimensional reduction due to shrinkage of the ink may be compensated in advance, and as a result, the final size of the TiO₂ nanostructure formed may be accurately formed to a design value. Such a method is effective in improving dimensional accuracy of fine patterns and in minimizing occurrence of distortion or defects of the patterns.

In addition, as shrinkage of the TiO₂ sol-gel occurs inside the mold, the adhesion between the TiO₂ nanostructure and the mold is naturally reduced, which prevents physical damage or deformation caused by an adhesive force that may occur when removing the mold.

That is, a minute gap is formed between the formed structure and the mold due to shrinkage of the TiO₂ sol-gel, allowing the mold to be more easily released and thus providing an advantage of removing the mold without structural defects in the metasurface (meta-atom). As a result, defects such as cracks, deformation, and peeling that may occur during a mold release process may be minimized, thus enabling stable and uniform manufacture of a high-quality TiO₂ crystalline metasurface over a large area. Therefore, according to the present exemplary embodiment, a uniform and high-quality TiO₂ crystalline metasurface may be stably manufactured over a large area, and thus there is an advantage of being able to implement a metasurface element having high optical conversion efficiency and excellent optical characteristics.

In an exemplary embodiment of the present disclosure, step (S300) may include: (S310) removing a residual solvent of the sol-gel ink at a temperature of 50° C. to 100° C.; and (S320) shrinking the nanostructure formed on the substrate by a heat treatment at a temperature of 180° C. to 250° C.

The TiO₂ sol-gel ink is in a liquid state in which nanoparticles or precursors are dispersed in a solvent. When the solvent remains without completely evaporating even after printing or coating, the solvent may rapidly evaporate during a subsequent heat treatment process, resulting in damage to fine patterns such as deformation, cracking, and formation of pores in the nanostructure. In addition, the residual solvent impairs structural stability, and when the mold is subsequently released, deformation of the nanostructure may occur due to a change in adhesive force during mold release.

When the residual solvent is effectively removed at an appropriate temperature and pressure, the solvent in the nanostructure evaporates uniformly, which may minimize distortion of fine patterns and non-uniform shrinkage. A heat treatment performed in a state where the solvent is removed induces uniform shrinkage of the TiO₂ nanostructure, which improves structural stability of the nanopattern.

In particular, when the residual solvent remains, a strong adhesive force is generated between the mold and the TiO₂ nanostructure, making mold release difficult. However, through removal of the residual solvent and uniform shrinkage, the adhesive force is reduced, which facilitates mold release.

Therefore, removal of the residual solvent may significantly improve efficiency and reliability of the manufacturing process by maintaining the precision of fine patterns, while reducing the adhesive force between the mold and the nanostructure due to shrinkage, thus enabling stable and repetitive mold release without damage to the mold.

Specifically, in step (S310), the temperature for removal of the residual solvent may have a lower limit of 50° C. or higher, 55° C. or higher, 60° C. or higher, 65° C. or higher, 70° C. or higher, 75° C. or higher, or 80° C. or higher, and may have an upper limit of 100° C. or lower, 95° C. or lower, 90° C. or lower, or 85° C. or lower, but is not limited thereto. More specifically, the temperature may be 50° C. to 100° C., 60° C. to 100° C., or 70° C. to 90° C., and more preferably may be 75° C. to 85° C. When the above temperature range is exceeded, defects such as bubble generation inside the nanostructure, and crack and void formation due to pressure increase may be induced. Therefore, when the above temperature range is satisfied, the entire structure shrinks at a constant ratio, which provides an advantage of maintaining pattern precision.

In an exemplary embodiment of the present disclosure, in order to form a uniform nanostructure, in step (S310), the residual solvent may be removed by applying a pressure of 300 kPa to 600 kPa.

Specifically, in step (S310), the residual solvent may be removed by applying a pressure having a lower limit of 300 kPa or higher, 350 kPa or higher, 400 kPa or higher, 450 kPa or higher, or 500 kPa or higher, and an upper limit of 600 kPa or lower, 580 kPa or lower, 560 kPa or lower, 540 kPa or lower, 520 kPa or lower, or 500 kPa or lower. More specifically, the pressure may be 300 kPa to 600 kPa, 350 kPa to 600 kPa, 400 kPa to 600 kPa, 450 kPa to 600 kPa, or 450 kPa to 550 kPa, but is not limited thereto.

When the above pressure range is exceeded, excessive pressure may be applied to the uncured sol-gel nanostructure, causing deformation or cracks. When the above pressure range is less than the lower limit, the residual solvent in the sol-gel ink may not be sufficiently removed, such that pores or cracks may be formed, or the nanostructure may shrink non-uniformly during the preliminary heat treatment of step (S320) or the crystallization step of step (S400). Therefore, when a pressure within the above range is applied, the vapor pressure of the solvent increases, such that the solvent may be rapidly and stably removed even at a relatively low temperature. In addition, under the above pressurizing conditions, capillary force is enhanced, such that even the solvent in a deep layer of the ink may be smoothly removed and uniformity of the nanostructure pattern may be ensured.

In an exemplary embodiment of the present disclosure, step (S320) is a step of shrinking the nanostructure formed on the substrate by a heat treatment at a temperature of 180° C. to 250° C.

The heat treatment of step (S320) serves to partially cure and shrink the TiO₂ nanostructure, which is still soft after a nanoimprint process, thereby reducing the adhesive force with the mold. Through this, damage and deformation of the TiO₂ nanostructure during mold release may be prevented, and mold release may be facilitated. That is, step (S320) serves as a preliminary heat treatment (pre-baking or soft baking), thereby contributing to improvement in structural stability and productivity of the metasurface.

In an exemplary embodiment of the present disclosure, the mold may be formed of a polymer having a heat distortion temperature of 250° C. or higher.

A mold formed of a low heat-resistant material such as polydimethylsiloxane (PDMS) has a limitation in that deformation occurs during the heat treatment process of step (S300), resulting in degradation of pattern accuracy and impossibility of repeated reuse. On the other hand, the present disclosure enables multiple reuses by using a high heat-resistant polymer mold that withstands a heat treatment process of 200° C. or higher in step (S300), and may enhance economic efficiency and reliability of the manufacturing process.

More specifically, the mold may be formed of polyimide, but is not limited thereto. A polyimide mold has an advantage in that a high-quality metasurface may be manufactured by preventing deformation during high-resolution pattern transfer and heat treatment processes due to excellent heat resistance and chemical stability.

Next, the TiO₂ crystallization of step (S400) will be described in detail.

In a conventional resin-based nanoimprint process, the resin nanopattern is softened or melted by heat during a crystallization step, resulting in loss of structural stability. Accordingly, there has been a problem in that it is difficult to crystallize amorphous TiO₂ dispersed in the resin into anatase or rutile at a high temperature. On the other hand, in the present disclosure, sol-gel TiO₂ itself is patterned rather than a resin binder, such that TiO₂ may be stably crystallized through a heat treatment at a high temperature after mold release, thus enabling implementation of a metasurface having a high refractive index and a high conversion efficiency.

In an exemplary embodiment of the present disclosure, a heat treatment temperature of step (S400) may be 400° C. to 1,000° C.

As an example, in a range of 400° C. to 700° C., TiO₂ is mainly formed into an anatase crystalline phase, and the refractive index reaches a range of about 2.4 to 2.5, such that the metasurface may exhibit a high conversion efficiency and excellent optical performance.

As an example, in a range of 700° C. to 1,000° C., TiO₂ is crystallized into a rutile crystalline phase, and the refractive index further increases to 2.7 or higher or 2.8 or higher, such that optical focusing efficiency and color conversion efficiency of the metasurface may be maximized.

Therefore, the present disclosure has an advantage in that those skilled in the art may selectively form an anatase phase or a rutile phase by controlling the heat treatment temperature in step (S400) according to the purpose of the metasurface to be used, which allows free design of the refractive index and optical performance of the metasurface.

In an exemplary embodiment of the present disclosure, a pattern period of the TiO₂ metasurface may be 70 nm to 450 nm.

Specifically, a lower limit of the pattern period may be 70 nm or more, 90 nm or more, 100 nm or more, 120 nm or more, 140 nm or more, 160 nm or more, 180 nm or more, 200 nm or more, 220 nm or more, 240 nm or more, 260 nm or more, 280 nm or more, or 300 nm or more, and an upper limit of the pattern period may be 450 nm or less, 430 nm or less, 410 nm or less, 390 nm or less, 370 nm or less, or 350 nm or less, but the present disclosure is not limited thereto.

More preferably, the pattern period may be 70 nm to 450 nm, 70 nm to 400 nm, 100 nm to 400 nm, 150 nm to 400 nm, 100 nm to 380 nm, 100 nm to 360 nm, or 150 nm to 350 nm, but is not limited thereto, and those skilled in the art may appropriately select the pattern period of the metasurface so as to control the optical performance.

As the pattern period of the TiO₂ metasurface is finely formed to 450 nm or less or 350 nm or less, precise phase control may be achieved at a high spatial frequency. This provides an advantage in that a metasurface having high resolution and a high numerical aperture (NA) may be designed.

The sol-gel-based manufacturing process of the present disclosure may effectively compensate for shrinkage and deformation, thus enabling stable formation of a uniform and defect-free nanostructure even at a pattern period of 450 nm or less or 350 nm or less. Through this, formation of ultra-fine patterns and manufacture of high-resolution optical elements, which have been difficult in conventional processes, may be achieved, and large-area, high-efficiency mass production of high-performance metasurfaces may be realized.

In an exemplary embodiment of the present disclosure, a meta-particle of the TiO₂ crystalline metasurface may have a height of 300 nm to 650 nm, a length of 150 nm to 300 nm, and a width of 50 nm to 260 nm.

As an example, when the TiO₂ crystal of the metasurface is amorphous, a meta-particle may have a height of 550 nm to 650 nm, a length of 150 nm to 265 nm, and a width of 100 nm to 150 nm or 200 nm to 260 nm. More specifically, the height may be 600 nm, the length may be 260 nm, and the width may be 116 nm, but the present disclosure is not limited thereto.

When the TiO₂ crystal is amorphous and the height, length, and width of the meta-particle satisfy the above ranges, the metasurface may exhibit a high conversion efficiency of 60% or more, 62% or more, 64% or more, 66% or more, 68% or more, 70% or more, 72% or more, 73% or more, or 74% or more.

As an example, when the TiO₂ crystal of the metasurface is anatase, a meta-particle may have a height of 550 nm to 650 nm, a length of 50 nm to 265 nm, and a width of 50 nm to 260 nm. Specifically, the meta-particle may have a height of 550 nm to 650 nm, a length of 60 nm to 120 nm or 170 nm to 230 nm, and a width of 50 nm to 120 nm or 160 nm to 230 nm. More preferably, the height may be 600 nm, the length may be 212 nm, and the width may be 78 nm, but the present disclosure is not limited thereto.

When the height, length, and width of the meta-particle of the anatase crystal satisfy the above ranges, the metasurface may exhibit a conversion efficiency of 70% or more, 72% or more, 74% or more, 76% or more, 78% or more, 80% or more, 81% or more, 82% or more, or 83% or more, and more preferably, may exhibit a high conversion efficiency of 84% or more.

As an example, when the TiO₂ crystal of the metasurface is rutile, a meta-particle may have a height of 550 nm to 650 nm, a length of 50 nm to 200 nm, and a width of 50 nm to 200 nm. More preferably, the height may be 600 nm, the length may be 175 nm, and the width may be 94 nm, but the present disclosure is not limited thereto.

When the height, length, and width of the meta-particle of the rutile crystal satisfy the above ranges, the metasurface may exhibit a conversion efficiency of 75% or more, 77% or more, 80% or more, 82% or more, 84% or more, 86% or more, 88% or more, 90% or more, 92% or more, 94% or more, 96% or more, 97% or more, or 98% or more, and more preferably, may exhibit a remarkably high conversion efficiency of 99% or more.

In an exemplary embodiment of the present disclosure, a TiO₂ crystalline metasurface manufactured by the method for manufacturing a TiO₂ crystalline metasurface according to the present disclosure may be provided.

In an exemplary embodiment of the present disclosure, the TiO₂ crystal may be in an anatase crystalline phase or a rutile crystalline phase.

Specifically, an anatase TiO₂ crystal may have a refractive index of 2.4 to 2.5, and when the crystal is in a rutile crystalline phase, the refractive index may be 2.8 or higher, which results in a higher refractive index. When the high-refractive-index crystalline phase is contained, a phase control range of light may be widened, which increases design flexibility of the metasurface, and a higher conversion efficiency may be exhibited even under the same structural conditions. Therefore, a high-performance and broadband metasurface may be implemented.

In an exemplary embodiment of the present disclosure, the metasurface may have a refractive index of 2.8 or higher in a visible wavelength region.

As the refractive index increases, a phase delay effect of the meta-atom may be maximized, which enables high conversion efficiency and precise phase control even with a small structure, and thus, a high-performance metasurface optical element capable of high resolution, high NA, and broadband applications may be implemented.

In an exemplary embodiment of the present disclosure, a conversion efficiency of the metasurface may be 80% or more in a wavelength region of 400 nm to 700 nm.

Specifically, since the metasurface according to the present disclosure contains a highly crystalline TiO₂ crystal, the metasurface may exhibit a high conversion efficiency of 80% or more, 82% or more, 84% or more, 86% or more, 88% or more, 90% or more, 92% or more, 94% or more, 96% or more, 98% or more, 99% or more, or 99.5% or more in a wavelength region of 400 nm to 700 nm.

In an exemplary embodiment of the present disclosure, an optical element including the metasurface may be provided.

For example, the optical element may be an element that performs wavefront control, polarization control, beam steering, or light-condensing functions, and specifically may include, but is not limited to, a metalens, a sensor for an autonomous vehicle, a wavefront and polarization control element for optical communication, a planar holographic imaging element, an optical unit for a panoramic camera, a projection and reception optical unit for a three-dimensional facial recognition camera, and an in/out coupler and a wavefront shaping element for augmented reality (AR)/virtual reality (VR) displays. In addition, those skilled in the art may utilize the high refractive index and high conversion efficiency effects of the present disclosure by appropriately modifying and designing the metasurface to be applied to optical elements for various applications, such as imaging, sensing, communication, display, and security identification. Accordingly, the method for manufacturing a TiO₂ crystalline metasurface according to the present disclosure, by applying sol-gel-based nanoimprint lithography, simplifies the process, increases the processing speed, and enables wafer-scale large-area patterning, as compared with conventional electron beam lithography or ALD processes.

In addition, by designing the nanopattern of the mold to be 20% to 30% larger than a target meta-atom in consideration of a shrinkage problem occurring during a drying and heat treatment process specific to the sol-gel method, pattern distortion and dimensional variation of the final metasurface may be effectively minimized. By reducing an adhesive force between the mold and the nanostructure through a pre-heat treatment, stable and repeatable mold release may be achieved, such that mold releasability may be improved and pattern precision may be maintained.

In addition, by adjusting heat treatment temperature conditions, an anatase crystalline phase or a rutile crystalline phase may be selectively implemented, and by optimizing a meta-atom structure, a conversion efficiency of up to 99.7% may be achieved, which provides advantageous effects in implementing high-resolution and high-efficiency metasurfaces.

Hereinafter, the present disclosure will be described in detail through examples and the like to facilitate understanding. However, the examples according to the present disclosure are not limited to the examples described herein and may be modified in various other forms, and the scope of the present disclosure should not be construed as being limited to the following examples. The examples of the present disclosure are provided to more fully describe the present disclosure to those skilled in the art, and are provided only to sufficiently convey the spirit of the present disclosure to those skilled in the art.

### Preparation Example 1: Preparation of TiO₂ Sol-Gel Ink

9.6 ml of diethanolamine (DEA) was added while stirring 134.56 ml of ethanol with a stirrer at 50° C., and then, the mixture was homogenized with a magnetic stirrer for 2 hours. 6.81 ml of titanium butoxide (TBOT), 20 ml of ethanol, and 0.9 ml of distilled water were added. The mixture was continuously stirred until the solution became transparent, and the reaction was performed to synthesize a TiO₂ sol-gel ink.

### Example 1: Manufacture of Amorphous-Phase Metasurface

A manufacturing process diagram of the metasurface is illustrated in FIG. 2.

### 1) Mold Fabrication

Meta-atoms in a master stamp were fabricated to be about 30% larger than target dimensions to compensate for shrinkage. A 12-inch master stamp was fabricated through continuous exposure in an array pattern of 1-cm metalenses using an ArF immersion scanner.

Subsequently, a replica mold having an inverse pattern of the master stamp was fabricated using polyimide with a high thermal deformation temperature of 250° C. or higher. The polyimide replica mold was fabricated by spin-coating a polyimide solution onto the master stamp, covering the spin-coated polyimide solution with a polyimide film, and curing the polyimide at 300° C. The cured polyimide was released from the master stamp to complete the replica mold.

### 2) Metasurface Manufacture

The sol-gel coating solution synthesized in Preparation Example 1 was spin-coated onto the replica mold, and the mold was placed on a sapphire substrate. Subsequently, a pressure of 500 kPa was applied at 80° C. to absorb the residual solvent and solidify the TiO₂ sol-gel coating solution.

Subsequently, a heat treatment was performed at 200° C. for 20 minutes to shrink the TiO₂ nanostructure, and the mold was released. After mold release, the TiO₂ nanostructure was annealed at 400° C. for 1 hour to form an amorphous phase.

### Example 2: Manufacture of Anatase Crystalline Metasurface

A metasurface was manufactured in the same manner as in Example 1, except that a heat treatment was performed on the TiO₂ nanostructure separated from the mold at 600° C.

### Example 3: Manufacture of Rutile Crystalline Metasurface

A metasurface was manufactured in the same manner as in Example 1, except that a heat treatment was performed on the TiO₂ nanostructure separated from the mold at 800° C.

### Comparative Example 1: Metasurface Manufactured by Polymer Epoxy Resin Containing Amorphous TiO₂

### 1) Manufacture of Comparative Example 1

A master stamp was fabricated using photolithography or electron beam lithography. A mold having an inverse pattern was replicated from the master stamp using h-polydimethylsiloxane (h-PDMS) and polydimethylsiloxane (PDMS). Next, a TiO₂ particle-embedded resin (PER) containing amorphous TiO₂ nanoparticles, a polymer binder, a curing agent, and a solvent was prepared. After the TiO₂ PER was applied onto a glass substrate and spin-coated, the mold having an inverse pattern was placed over the substrate, and curing was performed under ultraviolet (UV) irradiation at a pressure of 30 kPa and a temperature of 80° C.

After completion of curing, the PDMS mold was removed to form a metasurface composed of TiO₂ nanoparticles on the substrate.

### 2) Possibility of TiO₂ Crystallization of Metasurface of Comparative Example 1 Through Heat Treatment

The manufactured metasurface of Comparative Example 1 was subjected to an additional heat treatment process to evaluate whether the amorphous TiO₂ nanoparticles could be converted into an anatase crystalline phase or a rutile crystalline phase.

As a result of the heat treatment at 600° C., it was observed that the resin matrix softened, decomposed, and carbonized within this temperature range, causing the collapse of the fine patterns. Accordingly, it was confirmed that crystallization of TiO₂ could not be controlled by the additional heat treatment on the resin-based metasurface of Comparative Example 1, assuming preservation of the fine pattern structure.

### Comparative Example 2: Metasurface Coated with TiO₂ On UV-Curable Resin Pattern

### 1) Manufacture of Comparative Example 2

A master stamp was fabricated using photolithography or electron beam lithography. A mold having an inverse pattern was replicated from the master stamp using h-PDMS and PDMS. Next, a UV-curable resin (refractive index: 1.53) was applied onto the substrate and spin-coated, and then, the mold having an inverse pattern was placed over the substrate. Next, curing was performed under UV irradiation at a pressure of 30 kPa and a temperature of 80° C. After completion of curing, the PDMS was removed.

TiO₂, which is a high-refractive-index material, was coated by an ALD process onto the patterned resin structure to improve the conversion efficiency.

### 2) Possibility of TiO₂ Crystallization of Metasurface of Comparative Example 2 Through Heat Treatment

The manufactured metasurface of Comparative Example 2 was subjected to an additional heat treatment process to evaluate whether the amorphous TiO₂ nanoparticles could be converted into an anatase crystalline phase or a rutile crystalline phase.

As a result of the heat treatment at 600° C., it was observed that the resin matrix softened, decomposed, and carbonized within this temperature range, causing the collapse of the fine patterns. Accordingly, it was confirmed that crystallization of TiO₂ could not be controlled by the additional heat treatment on the resin-based metasurface of Comparative Example 2, assuming preservation of the fine pattern structure.

### Comparative Example 3: Metasurface Manufactured Using TiO₂ Nanoparticle Colloid

### 1) Manufacture of Comparative Example 3

A master stamp was fabricated using photolithography or electron beam lithography. A mold having an inverse pattern was replicated using the master stamp using a polymer material such as PDMS. Next, a TiO₂ nanoparticle colloidal solution containing TiO₂ nanoparticles, an anionic surfactant, and a silane coupling agent was prepared.

After the TiO₂ nanoparticle colloidal solution was applied onto a glass substrate and spin-coated, the mold having an inverse pattern was placed over the substrate, and curing was performed under UV irradiation at a pressure of 30 kPa and a temperature of 80° C. After completion of curing, the PDMS was removed to form a metasurface composed of TiO₂ nanoparticles on the substrate.

### 2) Possibility of TiO₂ Crystallization of Metasurface of Comparative Example 3 Through Heat Treatment

The manufactured metasurface of Comparative Example 3 was subjected to an additional heat treatment process to evaluate whether the amorphous TiO₂ nanoparticles could be converted into an anatase crystalline phase or a rutile crystalline phase.

As a result of the heat treatment at 600° C., it was observed that the organic matrix components contained in the colloidal matrix decomposed at a high temperature, leading to the collapse of the fine patterns. Accordingly, it was confirmed that crystallization of TiO₂ could not be controlled by the additional heat treatment on the colloid-based metasurface of Comparative Example 3, assuming preservation of the fine pattern structure.

### Evaluation Example 1: Evaluation of TiO₂ Crystallization Depending on Heat Treatment Temperature of Sol-Gel Ink

The sol-gel ink of Preparation Example 1 was applied onto a substrate and sintered at 200° C., 400° C., 600° C., and 800° C. for 1 hour. The crystalline state of TiO₂ was analyzed by X-ray diffraction (XRD) analysis.

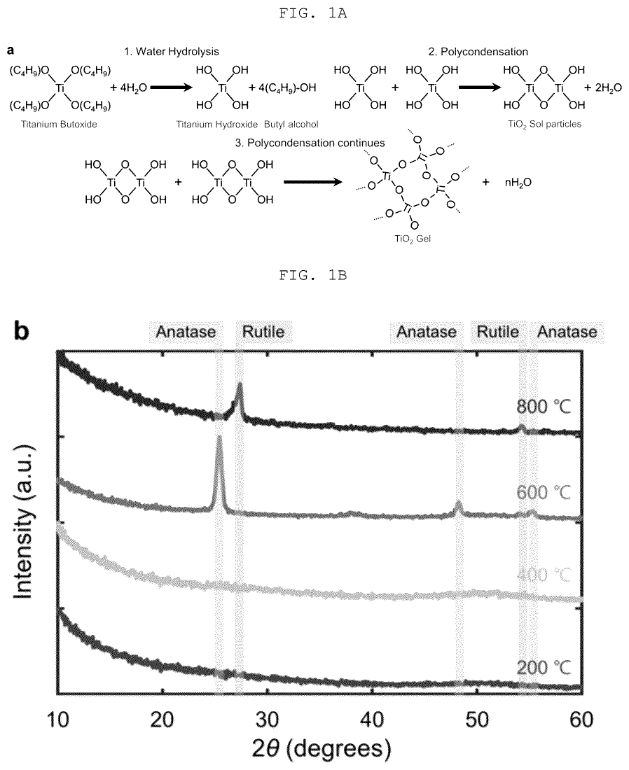

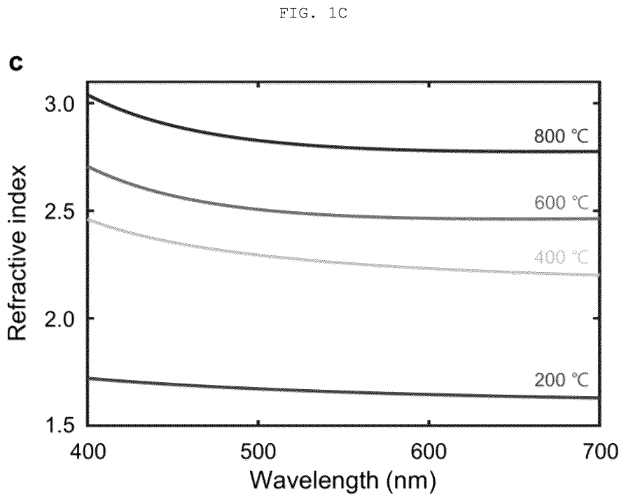

Referring to FIG. 1B, the TiO₂ films sintered at 200° C. and 400° C. did not show distinct peaks in the XRD analysis. On the other hand, the film sintered at 600° C. exhibited peaks corresponding to the anatase pattern, and the film sintered at 800° C. exhibited rutile peaks. Accordingly, it was confirmed that the films sintered at 600° C. and 800° C. formed anatase and rutile crystalline phases, respectively.

### Evaluation Example 2: Evaluation of Refractive Index Depending on Heat Treatment Temperature

FIG. 1C illustrates the change in refractive index in the wavelength range of 400 nm to 700 nm for the TiO₂ films heat-treated at 200° C. to 800° C. Referring to FIG. 1C, it was confirmed that as anatase and rutile phases were formed, the refractive indices exhibited values of 2.5 or higher and 2.8 or higher, respectively.

That is, as the heat treatment temperature increased, the crystallinity of the TiO₂ film increased and the refractive index was measured to be as high as 2.5 or greater, which was advantageous for designing high-performance metasurfaces.

### Evaluation Example 3: Evaluation of Conversion Efficiency of Metasurface

The conversion efficiency of converting incident light on the metasurface into a desired phase or polarization was calculated using a rigorous coupled-wave analysis (RCWA) method. The evaluation was performed by varying various parameters such as the period, height, length, and width of the meta-atoms according to the methods of Examples 1 to 3.

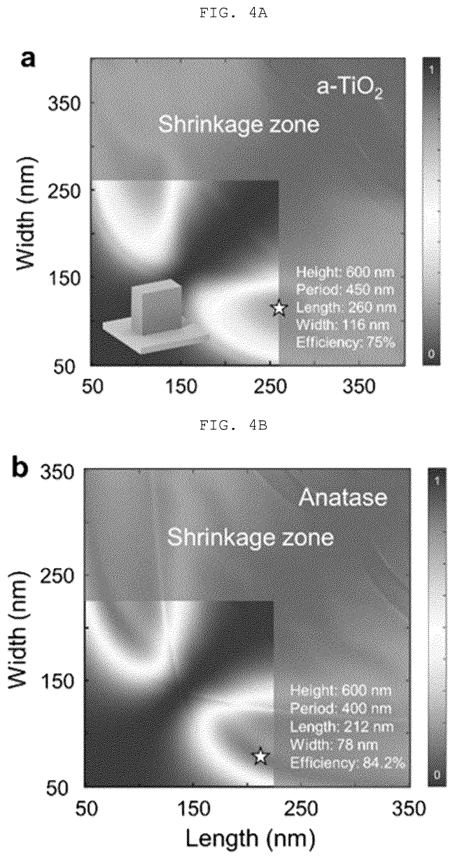

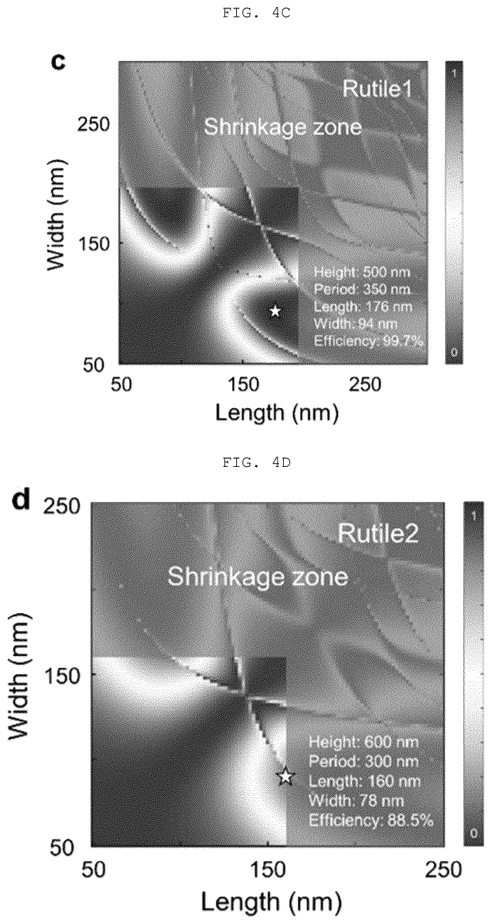

FIGS. 4A to 4D illustrate graphs showing the conversion efficiency of the metasurface according to the height, length, period, and width of the meta-atom. The efficiency of the metasurface was calculated while keeping the thickness and period fixed and varying the width and length.

The shrinkage zone of FIGS. 4A to 4D refers to a region in which formation is difficult in the nanoimprint process using the sol-gel coating solution of the present disclosure.

Referring to FIG. 4A, it was confirmed that when TiO₂ was amorphous, the maximum conversion efficiency was measured to be about 75% when the meta-atom had a height of 600 nm, a period of 450 nm, a length of 260 nm, and a width of 116 nm.

Referring to FIG. 4B, it was confirmed that when TiO₂ was anatase crystals, the maximum conversion efficiency was measured to be as high as about 84.2% when the meta-atom had a height of 600 nm, a period of 400 nm, a length of 212 nm, and a width of 78 nm.

Referring to FIG. 4C, it was confirmed that in the case where TiO₂ was rutile crystals, the maximum conversion efficiency was measured to be as high as about 99.7% when the meta-atom had a height of 500 nm, a period of 350 nm, a length of 176 nm, and a width of 94 nm. Referring to FIG. 4D, it was confirmed that the maximum conversion efficiency was measured to be as high as about 88.5% when the meta-atom had a height of 600 nm, a period of 300 nm, a length of 160 nm, and a width of 78 nm.

It was confirmed that the optimized meta-atoms for the amorphous, anatase, and rutile phases achieved high conversion efficiencies of about 75%, 84.2%, and 99.7%, respectively, even taking shrinkage into consideration.

That is, it was confirmed that, by subjecting the metasurface manufactured by the manufacturing method according to the present disclosure to thermal nanoimprint lithography and heat treatment processes using a TiO₂ sol-gel coating solution, high-efficiency metasurfaces (metalenses) having efficiencies of 88% or more, 90% or more, 95% or more, and 99% or more were manufactured. In particular, in the rutile phase, a high efficiency of 88.5% was obtained even at a small period of 300 nm.

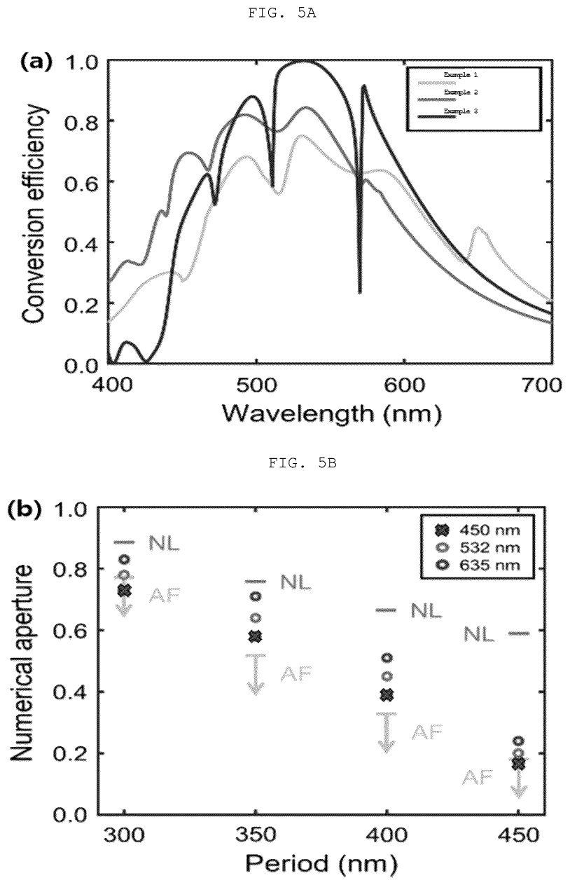

FIG. 5A illustrates broadband conversion efficiency characteristics from 400 nm to 700 nm of meta-atoms designed for amorphous TiO₂, anatase, and rutile, and FIG. 5B illustrates numerical apertures (NAs) of the metalenses calculated at different periods (300 nm, 350 nm, 400 nm, and 450 nm) for respective wavelengths (450 nm, 532 nm, and 635 nm).

Referring to FIG. 5A, it was shown that the conversion efficiency varied in the visible wavelength range of 400 to 700 nm for each phase of Amorphous (a-TiO₂), Anatase, and Rutile 1.

In particular, the rutile phase exhibited the highest efficiency over the entire range and showed excellent performance with values of 0.9 or higher around 500 to 550 nm. This indicates that the crystallinity of TiO₂ is closely related to the increase in refractive index and that the high refractive index of the rutile phase (about 2.8) enabled superior optical conversion performance.

Referring to FIG. 5B, it was confirmed that as the period of the meta-atom decreased, a higher numerical aperture (NA) was realized, which indicated high resolution and excellent light-focusing performance. In the graph, the Nyquist Limit (NL) and Aliasing-Free (AF) regions are indicated. The NL represents the threshold at which ideal diffraction performance is limited by aliasing, and the AF region refers to the range in which no aliasing occurs. Here, aliasing refers to a phenomenon in which a distorted phase is generated, rather than the originally intended phase distribution.

In particular, rutile was capable of realizing high NAs of 0.64 and 0.78 at periods of 350 nm and 300 nm, respectively, which resulted in excellent resolution and light-focusing capability. The metasurface according to the present disclosure is designed to operate in an intermediate region between the NL and AF, allowing an acceptable level of aliasing while minimizing performance degradation.

Accordingly, high-performance metalenses requiring a high NA are designed with reduced periods, and in this case, high-refractive-index materials such as rutile-phase TiO₂ may be used. In conclusion, the metasurface manufactured by the manufacturing method according to the present disclosure is optimized to operate in an intermediate region between the NL and AF regions, enabling realization of a high NA while minimizing aliasing.

### Evaluation Example 4: Evaluation of Diffraction Efficiency of Metalens

In order to adjust the NA of the metalens, the diameter and focal length were controlled, and the NA was adjusted using the following Equation 1.

$$NA = 2 * sin \{ {tan}^{- 1} ( \frac{Diameter}{2 * Focal length} ) \} \qquad ( Equation 1 )$$

When the NA was increased, the diameter was increased at the same focal length, or the focal length was decreased at the same diameter. In addition, in order to minimize aliasing when the NA increased, the period of the meta-atom was generally reduced.

An optical power meter was used to measure the diffraction efficiency. When the laser light passed through the metalens, the light was focused at the focal length position, and an aperture or pinhole corresponding to about three times the full width at half maximum (FWHM) of the point spread function (PSF) of the lens, which had been measured in advance, was prepared.

After the light focused by the metalens passed through the aperture or pinhole placed at the focal length position, the flux of the transmitted light was measured with the optical power meter to measure the diffraction efficiency.

Table 1 shows the diffraction efficiencies of the metalenses measured by the above-described diffraction efficiency measurement method.

TABLE 1

| | | Period | NA at | | | |
|---|---|---|---|---|---|---|
| | Material | (nm) | 532 nm | Blue | Green | Red |
| Comparative | a-TiO₂ | 450 | 0.2 | 22% | 56% | 32% |
| Examples 1 | | | | | | |
| to 3, and | | | | | | |
| Example 1 | | | | | | |
| Example 2 | Anatase | 400 | 0.45 | 28% | 71% | 16% |
| Example 3 | Rutile | 350 | 0.2 | 43% | 77% | 34% |
| Example 3 | Rutile | 350 | 0.64 | 28% | 37% | 22% |
| Example 3 | Rutile | 300 | 0.78 | 8% | 11% | 9% |

Referring to Table 1, it was found that the metalenses having crystallinity (anatase and rutile) exhibited significantly higher diffraction efficiency in the green wavelength region compared to those with amorphous (a-TiO₂). Under the same NA condition (0.2), it was confirmed that Example 3 containing a rutile crystal (350 nm) exhibited higher efficiency across the entire blue/green/red wavelength regions than Comparative Examples 1 to 3 containing amorphous crystals. Thus, it was found that crystalline TiO₂ contributed to the improvement of conversion efficiency. That is, it was found that as the refractive index increased, the conversion efficiency increased.

Next, the performance of the metalenses manufactured by the conventional manufacturing methods (Comparative Examples 1, 2, and 3) was compared with that of the metalenses of the examples of the present disclosure.

TABLE 2

| | | Refractive | | | |
|---|---|---|---|---|---|
| | | index @ | | Simulated | Measured |
| | Material | 532 nm | Period | efficiency | efficiency |
| Example 3 | Rutile | 2.8 | 350 nm | 99.7% | 77% |
| Example 2 | Anatase | 2.49 | 400 nm | 84% | 71% |
| Comparative | TiO₂ PER | 1.94 | 450 nm | 63% | 33% |
| Example 1 | | | | | |
| Comparative | Resin + | 1.53 (Resin) | 450 nm | 89% | 56% |
| Example 2 | TiO₂ | 2.36 (TiO₂) | | | |
| Comparative | TiO₂ | 2.15 | 430 nm | 82% | 75% |
| Example 3 | NPs + | | | | |
| | binder | | | | |

Referring to Table 2, Comparative Example 1, which is a metasurface manufactured based on TiO₂ PER, had a relatively low refractive index of 1.94 compared to the examples. As a result, the conversion efficiency simulated in the 450 nm period pattern was only 63%, and the measured efficiency was as low as 33%.

In addition, Comparative Example 2 manufactured based on a TiO₂ resin showed a relatively high simulated efficiency of 89%, but the measured efficiency remained at 56%, resulting in a relatively large efficiency loss. Comparative Example 2 attempted to improve the efficiency by coating TiO₂ on the resin pattern, but it was found that the performance was limited compared to the examples due to the low refractive index of the resin and the losses generated during the process.

Comparative Example 3 manufactured based on a TiO₂ nanoparticle colloid formed a composite having a refractive index of 2.15. Thus, it was found that the refractive index of the binder (polymer) used together with the nanoparticles was relatively low, which limited the overall refractive index of the composite to 2.15. In addition, it was confirmed that a colloid-based patterning process, such as in Comparative Example 3, could be affected by particle size and dispersion state in terms of pattern uniformity and resolution, making it difficult to realize high-resolution patterns with fine periods (350 nm or less).

On the other hand, it was found that the metasurfaces according to the present disclosure containing sol-gel-based rutile-phase or anatase-phase TiO₂ crystals exhibited higher efficiency and smaller periods than those manufactured by the manufacturing methods of the comparative examples. In particular, in the examples, by applying the high crystallinity of rutile-phase TiO₂, a high refractive index of 2.8 or higher, and a fine period structure of 350 nm, a simulated efficiency of 99.7% and a measured efficiency of 77% were achieved. In particular, it was found that the efficiencies of the examples were slightly higher than those of Comparative Example 3, while having smaller periods, which was advantageous for forming high-resolution patterns.

That is, it was found that metasurfaces formed with smaller periods were advantageous for forming high-NA metasurfaces, and that the sol-gel nanoimprint method of the present disclosure allowed the manufacture of lenses having efficiencies equivalent to those of conventional high-refractive-index material-based metalenses in a more economical manner.

As set forth above, the method for manufacturing a sol-gel-based TiO₂ crystalline metasurface according to an exemplary embodiment of the present disclosure may selectively form anatase and rutile crystalline phases to realize a high-refractive-index metasurface.

The method for manufacturing a sol-gel-based TiO₂ crystalline metasurface according to an exemplary embodiment of the present disclosure may optimize the optical performance of the metasurface by controlling the heat treatment temperature.

The method for manufacturing a sol-gel-based TiO₂ crystalline metasurface according to an exemplary embodiment of the present disclosure may manufacture a metasurface having high efficiency and high numerical aperture characteristics by utilizing crystalline TiO₂ with a high refractive index.

The method for manufacturing a sol-gel-based TiO₂ crystalline metasurface according to an exemplary embodiment of the present disclosure may stably implement uniform and defect-reduced nanopatterns by including a shrinkage-compensation design.

The method for manufacturing a sol-gel-based TiO₂ crystalline metasurface according to an exemplary embodiment of the present disclosure may manufacture a high-resolution nanostructure at a wafer scale with high speed and low cost.

While the exemplary embodiments of the present disclosure have been described above with reference to the accompanying drawings, it will be understood by those skilled in the art that the present disclosure may be practiced in various other specific forms without changing the technical spirit or essential characteristics thereof. Therefore, it is to be understood that the exemplary embodiments described above are illustrative rather than restrictive in all aspects.

What is claimed is:

1. A method for manufacturing a TiO₂ crystalline metasurface, the method comprising:
(S100) coating a substrate with a TiO₂ sol-gel ink;
(S200) arranging a mold having a concave nanopattern on the substrate coated with the TiO₂ sol-gel ink to form an assembly;
(S300) solidifying the TiO₂ sol-gel ink inside the assembly; and
(S400) after releasing the mold, performing a heat treatment on a TiO₂ nanostructure to crystallize TiO₂.

2. The method of claim 1, wherein step (S300) includes:
(S310) removing a residual solvent of the sol-gel ink at a temperature of 50° C. to 100° C.; and
(S320) shrinking the nanostructure formed on the substrate by a heat treatment.

3. The method of claim 2, wherein in step (S310), the residual solvent is removed by applying a pressure of 300 kPa to 600 kPa.

4. The method of claim 2, wherein the heat treatment of step (S320) is performed at a temperature of 180° C. to 250° C.

5. The method of claim 1, wherein the mold is formed of a polymer having a heat distortion temperature of 250° C. or higher.

6. The method of claim 1, wherein the mold is formed of polyimide.

7. The method of claim 1, wherein a heat treatment temperature of step (S400) is 600° C. to 1,000° C.

8. The method of claim 1, wherein the concave nanopattern of the mold is formed to be 20% to 30% larger in length than meta-particles to be manufactured.

9. A TiO₂ crystalline metasurface manufactured by the method for manufacturing a TiO₂ crystalline metasurface of claim 1.

10. The TiO₂ crystalline metasurface of claim 9, wherein the TiO₂ crystal is in an anatase crystalline phase or a rutile crystalline phase.

11. The TiO₂ crystalline metasurface of claim 9, wherein a pattern period of the TiO₂ metasurface is 70 nm or more and 450 nm or less.

12. The TiO₂ crystalline metasurface of claim 9, wherein a meta-particle of the TiO₂ crystalline metasurface has a height of 300 nm to 650 nm, a length of 150 nm to 300 nm, and a width of 100 nm to 260 nm.

13. The TiO₂ crystalline metasurface of claim 9, wherein a refractive index of the TiO₂ crystal is 2.8 to 3.2.

14. The TiO₂ crystalline metasurface of claim 9, wherein a conversion efficiency of the metasurface is 80% or more in a wavelength region of 400 nm to 700 nm.
